(19) United States
(12) Patent Application Publication
(10) Pub. No.: US 2018/0240206 A1
(43) Pub. Date: Aug. 23, 2018

(54) Method of placing orders in a defined area

(71) Applicant: Warner Dean Hawley, Palm Beach Gardens, FL (US)

(72) Inventor: Warner Dean Hawley, Palm Beach Gardens, FL (US)

(21) Appl. No.: 15/903,703

(22) Filed: Feb. 23, 2018

Related U.S. Application Data
(60) Provisional application No. 62/462,724, filed on Feb. 23, 2017.

(51) Int. Cl. G06Q 50/12; G06Q 20/34; G06K 7/14; G06Q 10/08

(52) U.S. Cl. CPC G06Q 50/12; G06Q 10/083; G06K 7/1413; G06Q 20/34

(57) ABSTRACT

Disclosed is a method of ordering food and beverages at a sports stadium, concert, or the like event. The method utilizes smart phone or the like technology, wherein an assigned Wi-Fi connection is provided within the stadium. The Wi-Fi connection allows the downloading of an App listing of the vendors and menus. An individual may order the food or beverage, and either provide a seat location or use the GPS locating ability of a smart device to provide the vendor with the approximate location. The vendor would employ a worker familiar with the stadium and trained to properly transverse steps for delivering the food and/or beverage to the individual.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/462,724, entitled “METHOD OF PLACING ORDERS IN A DEFINED AREA”, filed on Feb. 23, 2017, the contents of which is incorporated herein by reference.

### FIELD OF THE INVENTION

This invention is directed to the field of Apps that work in a defined area and, in particular, to a method of placing orders using a detectable smart device within the defined area.

### BACKGROUND OF THE INVENTION

Attending professional events can be exciting and expensive. Professional events include various sporting activities, concerts, and the like events that are held in a defined area. A defined area is can be considered a coliseum, stadium or other venue that is designed to position the patron close to the event. Professional events, especially sporting events, are most exciting because the outcome of the event is unpredictable, and strategy by the players and coaches can quickly change the outcome of a game. With the level of professional athletic talent that sports events now demand, player salaries and the associated costs for attending sports events has grown tremendously. The average fan does not want to leave their seat during the game, but their spouse, friend or children may not appreciate the intensity of the sport and seek food and beverages to further enjoy their experience.

As the sports events grow larger, the stadiums get bigger, adding more seating capacity. For instance, the Michigan college football stadium holds 107,601 and Ohio State's stadium holds 104,944 fans. Los Angeles Coliseum holds 93,607, and the stadium hosting the Dallas Cowboys holds 92,100 fans. Large stadiums are found throughout the United States and may also be used to house other sports. Stadiums used to support basketball and hockey may not be as voluminous as football stadiums, but still present similar problems to which this invention addresses.

Stadiums are designed to provide the individuals viewing the sporting event the best view possible by keeping the individual as close to the playing field as possible. The result is the use of very steep banks where each seat row of individuals is positioned higher than the seat row of individuals before them. To access the seats, one must climb or descend staircases that are extremely steep. For anyone to access the seats, much less run out for food to support a spouse, friend, or children, the person must either climb or descent steep steps. The transcending of steps is made especially dangerous when a game is being played, for the individual can easily be distracted. Having expended a large sum of money to attend the sports event, it is only naturally that the individual will attempt to watch as much of the action as possible. Add to this the likelihood that the individual is carrying food, or has been drinking, and the steep stairways become a dangerous proposition no matter how agile you are. For example, in 2013, a 32 year old man was killed when he fell from an elevated pedestrian walkway at San Francisco's Candlestick Park. Should an individual fan have bad knees, be overweight, or have any form of handicap, the individual must either forego the desired food and drink, or attempt to transition the steps during the sporting event.

Further frustration may be experienced when the individual who transitioned the stairs to find food or drink encounters a long line at the concession stand. Anyone who has attended such a sporting event has likely heard the roar of the crowd while standing in line for food. Not only is this frustrating, it is likely that the individual will not risk missing out on a play again and the concession stand will lose the income from food or beverage sales.

In an effort to assist the patron, the vendors have used individuals to carry drinks and snacks to the fans. Such individuals are paid employees, and are focused on selling product with little or no interest in the game. Further, vendor employees walk the stadium steps routinely so they are very accustom to the staircase transitions. Essentially, these are professionals capable of transitioning the steep steps with little effort. Unfortunately, under current practice, vendors may not be carrying the type of food or drink that is wanted, leaving the individual to transition the steps to furtherance of the desired food and beverage gathering task.

What is needed in the industry is a method of using professional vendors to carry the desired food and/or beverage to the individual fan.

### SUMMARY OF THE INVENTION

A method of ordering food and beverages while attending an event at a stadium or the like defined area. The method utilizes a smart phone, or like technology, wherein an assigned Wi-Fi connection is provided within the confines of a sports stadium. The Wi-Fi connection allows the downloading of an App listing of the vendors and food. An individual may order the food or beverage and either provide a seat location by inputting the location or scanning of an individual's seat ticket, or by use of the GPS locating ability of a smart device to provide the vendor with the approximate location. The vendor, using a worker familiar with the stadium and trained to properly transverse steps, then delivers the food and/or beverage to the individual.

An objective of the invention is to enhance the enjoyment of a sporting event by allowing food and beverages to be delivered to the individual watching the game, wherein the individual need not leave their assigned seat during the game.

Still another objective of the invention is to eliminate the risk of individuals leaving their seats during a sporting event.

Another objective of the invention is to increase vendor sales by providing access to vendors by individuals who otherwise would not choose to leave the sporting event during a game.

Still another objective of the invention is to enhance enjoyment of the game by using professional vendors to deliver food so that the patrons need not leave their seat or otherwise be lost trying to navigate a large venue.

Yet still another objective of the invention is to provide assistance to the handicap, elderly, parents with children, or anyone else that does not want to stand in concession or retail lines.

Still another objective of the invention is to provide individuals attending a sporting event a safer environment by reducing bodily contact with other individuals and the need to stand to allow others to pass from an assigned seat to a staircase, as well as eliminating food and beverage spills by individuals carrying items while distracted by the sporting event and possible preventing slip and fall incidents.

Still another objective of the invention is to address dehydration by eliminating the excuse of having to wait for a break in the sporting event and allowing an individual to easily order drinks at the first sign of dehydration.

Yet still another objective of the invention is to minimize the liability to the establishment by using professional delivery individuals thereby limiting the movement of patrons traversing the steep stairways.

Other objectives and further advantages and benefits associated with this invention will be apparent to those skilled in the art from the description, examples and claims which follow.

### BRIEF DESCRIPTION OF THE DRAWINGS

FIG. 1 is a flow schematic of the invention.

### DETAILED DESCRIPTION OF THE PREFERRED EMBODIMENT

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

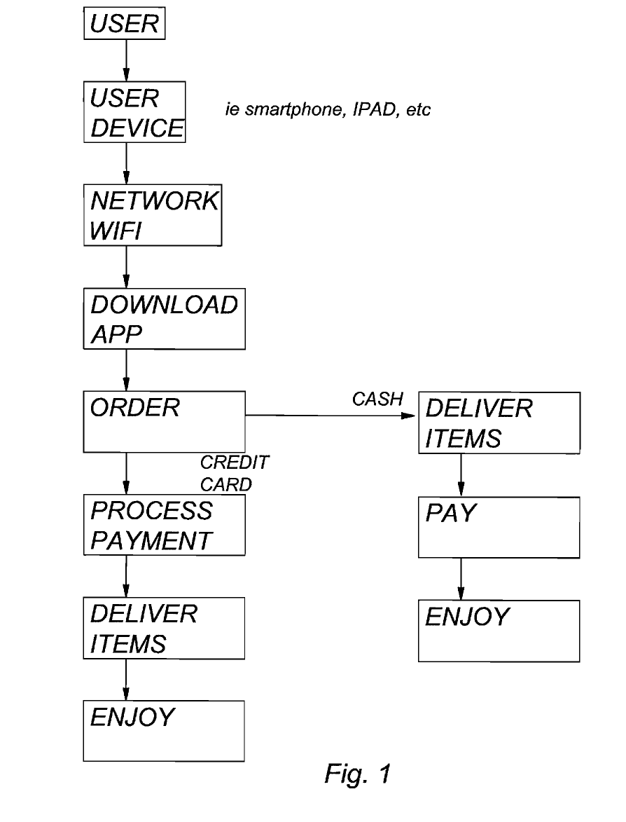

Referring now to the flow diagram of FIG. 1, disclosed is a method for receiving and delivering orders for goods, such as food, beverages or gifts, in a sports stadium or the like defined area. Unique to sporting events, concerts, and movie houses is that the general population is isolated for a period of time to enjoy the presentation occurring in the area. Using a sports stadium as the example, the stadium would be equipped with a Wi-Fi, Bluetooth, or a similar on-line connection service having a limited range. In particular, the range would be accessible only for those within the defined area of the stadium. With the Wi-Fi or Bluetooth system in operation, an individual with a smart phone, or like device, can search for on-line access, which is limited in scope by a controller of the system. The individual would be notified of a supplied online connection upon entering the stadium, and the individual would connect to the online connection using the smart device. Alternatively, the system connection can be discovered during a search process, no different than what the consuming public has become well accustomed to upon entering any establishment that may carry a Wi-Fi connection. Further, an App maybe preinstalled from a previous visit or if the individual downloaded the App in anticipation of visiting the establishment. Once a connection is made, the individual downloads an App to their smart device that lists the vendors within the stadium offering goods such as food, beverages or gifts that are capable of being delivered within the stadium. This becomes especially important in view of the current rules of bringing food and beverages into the stadium. Beverages are prohibited, as the security personnel are not capable of testing each of the liquids to assure the beverage is what the owner says it is. Once the App is downloaded, the individual may select a vendor by contacting the vendor through the App to order items selected from the vendor's online menu. The type of payment for the items is selected, being either a credit card or payment of cash.

The vendor can request a section, row, and seat assignment from the individual placing the order. Alternatively the individual may have their seat ticket scanned by a phone app to provide the seat assignment. The scanning can be performed by a smartphone having a scanning app to interpret the seat assignment using a graphic bar code, line bar code, or decifier of the numeral for the seat assignment. In instances where GPS is available (such as in those stadiums having an open roof), the vendor can detect the approximate location of the individual ordering the food. The vendor would then engage the services of an employee who is familiar with the stadium locations, and the transitioning of the steep steps found in most stadiums, for quick and safe delivery of food, beverages, and/or gifts. The use of vendor employees to deliver the food lessens the congestion of individuals and their families on the stairwells and allows them to watch the event that they have paid to attend. The transition of the steps is left to those individuals who are paid to quickly perform the task of delivering the goods and are familiar with the stadium. Allowing the vendor to simply pass the food/goods to the individual who ordered them in a manner similar to that found in a restaurant further eliminates the need for individuals to leave their seats and cause disruption with fellow fans.

The vendor may also provide an estimated delivery time and the exact amount due to the individual. This allows the individual to be prepared with the correct amount, if cash is the selected payment. Further, by notifying the individual when the courier of the goods is going to arrive, the individual can watch for the courier and help the courier spot their location, making for a faster transaction. Alternatively, the vendor can call or text the individual when the courier is to make the delivery, confirm the location of the individual, and verify the purchase of the goods to lessen or eliminate the chance of hoax calls. The present invention has the advantage of assisting the elderly and handicapped, who no longer have to deal with the rigors and obstacles of navigating up and down stairs and ramps to access certain goods.

Another advantage is that a family no longer has to be concerned about leaving to take the children to stand in lines at the concession stands.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for receiving and delivering food/beverage orders in a sports or the like defined area comprising the steps of:
notifying an individual entering a stadium of a supplied on-line connection;
connecting the individual to the on-line connection;
downloading an App to the individual's smart device that lists vendors offering goods within the stadium;
selecting a vendor by the application executing on the individual's smart device and reviewing the vendor's on-line menu;
ordering items by the application executing on the individual's smart device selected from the vendors on-line menu;
identifying the type of payment for the items selected by the application executing on the individual's smart device;
receiving payment for the items selected;
directing a vendor employee to deliver items selected by the individual;
delivering items selected to the individual.

2. The method for receiving and delivering food/beverage orders according to claim 3 wherein said on-line connection is a Wi-Fi.

3. The method for receiving and delivering food/beverage orders according to claim 3 wherein said on-line connection is a Bluetooth connection.

4. The method for receiving and delivering food/beverage orders according to claim 3, including the step of selecting the section, row and seat number of the individual ordering the food/beverage.

5. The method for receiving and delivering food/beverage orders according to claim 3, including the step of locating the section of the individual ordering the food/beverage by GPS coordinates.

6. The method for receiving and delivering food/beverage orders according to claim 3, including the step of estimating delivery time and notifying the individual ordering the food/beverage that the items are about to be delivered.

7. The method for receiving and delivering food/beverage orders according to claim 3 including the step of calling the individual who selected the items to be delivered to verify seat location.

8. The method for receiving and delivering food/beverage orders according to claim 4 wherein said step of selecting the section, row and seat number of the individual ordering the food/beverage is obtained by scanning an individual's seat ticket.
